(19) United States
(12) Patent Application Publication
(10) Pub. No.: US 2026/0064074 A1
(43) Pub. Date: Mar. 5, 2026

(54) IMAGE FORMING APPARATUS

(71) Applicant: CANON KABUSHIKI KAISHA, Tokyo (JP)

(72) Inventor: KENTARO YAMANA, Chiba (JP)

(21) Appl. No.: 19/241,937

(22) Filed: Jun. 18, 2025

(30) Foreign Application Priority Data
Aug. 29, 2024 (JP) 2024-147447

(51) Int. Cl. G03G 21/16

(52) U.S. Cl. CPC G03G 21/1633; G03G 2221/1654; G03G 2221/169

(57) ABSTRACT

An image forming apparatus includes: a front door covering a front side of an main body; a main body; a front door configured to cover a front side of the main body; a moving member configured to move with respect to the main body; an operation lever provided on the front side of the main body and configured to rotate between a locking position for locking the moving member and an unlocking position for unlocking the moving member, the operation lever being covered by the front door and being accessible by opening the front door; and a regulating member configured to move at least to a regulating position for regulating a rotation of the operation lever and to an allowing position for allowing the rotation of the operation lever.

### BACKGROUND

### Field of the Technology

The present disclosure relates to an image forming apparatus.

### Description of the Related Art

In an image forming apparatus such as a printer or a copying machine using an electrophotographic system, it may be necessary to replace a process unit including a photosensitive drum in order to prevent image quality degradation due to characteristic changes such as wear. When the process unit is attached and detached, it is effective to insert and remove the process unit in a front-rear direction by separating the photosensitive drum and an intermediate transfer belt from each other in order to prevent scratches on the photosensitive drum and then accessing the process unit from the front side of an main body from the viewpoint of securing a space for replacement work and workability.

In a case of a configuration in which the process unit is inserted and removed from the front side of the main body, it is necessary to attach and detach a process unit cover that positions the front side of the process unit with respect to the main body to and from the main body. Japanese Patent Application Laid-Open No. 2021-189297 discloses a method of easily fixing a process unit cover to an main body by operating a rotation lever.

Conventionally, in an image forming apparatus in which a service engineer performs replacement work of a process unit, a user may open a front door on the front side of an main body to access a conveyance unit for sheet jam processing.

However, when the user opens the front door, the user can access a rotation lever for attaching and detaching a process unit cover. Therefore, there is a possibility that the user unintentionally operates the rotation lever, for example, by hitting the rotation lever. In this case, the process unit cover is detached from the main body, the process unit is not positioned with respect to the main body, and a problem such as an abnormal image occurs.

In addition, it is conceivable to fix the rotation lever with a screw or the like in order to cope with the above-described problem, but in this case, a problem that the work load of the service engineer increases occurs.

### SUMMARY

According to a representative configuration of the present disclosure, an image forming apparatus includes: a main body; a front door configured to cover a front side of the main body; a moving member configured to move with respect to the main body; an operation lever provided on the front side of the main body and configured to rotate between a locking position for locking the moving member and an unlocking position for unlocking the moving member, the operation lever being covered by the front door and being accessible by opening the front door; and a regulating member configured to move at least to a regulating position for regulating a rotation of the operation lever and to an allowing position for allowing the rotation of the operation lever.

According to the present disclosure, it is possible to prevent a user from unintentionally operating an operation lever without impairing workability of a service engineer.

Features of the present disclosure will become apparent from the following description of embodiments with reference to the attached drawings. The following description of embodiments are described by way of example.

### BRIEF DESCRIPTION OF THE DRAWINGS

FIG. 1 is a cross-sectional view illustrating a schematic configuration of an image forming apparatus;

FIGS. 2A and 2B are perspective views of the image forming apparatus with a front door opened;

FIGS. 3A, 3B, and 3C are perspective views of an attachment/detachment lever and a lever lock member of an intermediate transfer belt unit;

FIGS. 4A, 4B, and 4C are perspective views of an attachment/detachment lever and a lever lock member of a process unit cover;

FIGS. 5A and 5B are top views of the attachment/detachment lever and the lever lock member of the process unit cover as viewed from above; and

FIGS. 6A and 6B are perspective views of the image forming apparatus with the front door opened.

### DESCRIPTION OF THE EMBODIMENTS

Hereinafter, embodiments of the present disclosure will be exemplarily described with reference to the drawings. However, dimensions, materials, shapes, relative arrangements, and the like of components described in the following embodiments should be appropriately changed depending on a configuration of an apparatus to which the present disclosure is applied and various conditions, and the scope of the present disclosure is not intended to be limited to them.

### (Image Forming Apparatus)

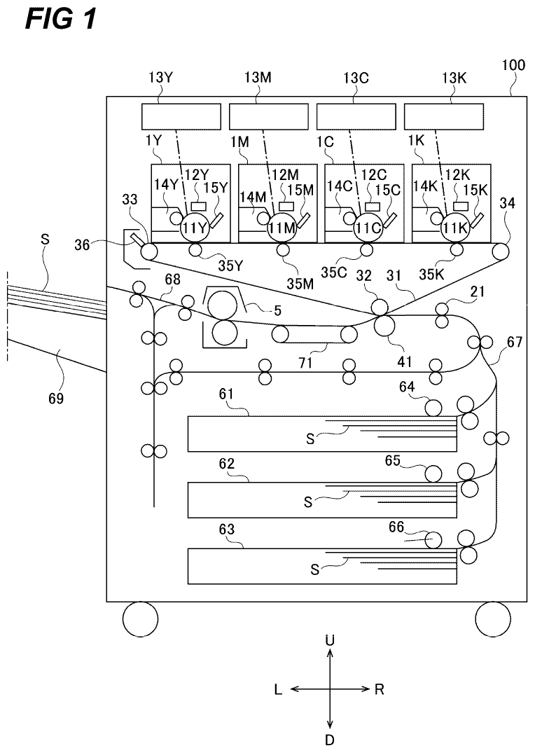

FIG. 1 is a cross-sectional view illustrating a schematic configuration of an image forming apparatus 100 according to the present embodiment. The image forming apparatus 100 illustrated in FIG. 1 is an image forming apparatus of a tandem type intermediate transfer system in which image forming portions 1Y, 1M, 1C, and 1K are arranged in series in a horizontal portion of an intermediate transfer belt 31 as an intermediate transfer member. The image forming apparatus 100 forms a full-color image on a sheet material S by an electrophotographic system according to an image signal transmitted from an external device.

The image forming portions 1Y, 1M, 1C, and 1K form toner images of respective colors of yellow, magenta, cyan, and black on photosensitive drums 11Y, 11M, 11C, and 11K as photoreceptors, and primarily transfer the toner images to the same image position on the intermediate transfer belt 31.

The intermediate transfer belt 31 is stretched and rotated by a drive roller 33, a tension roller 34, and a counter roller 32 for performing secondary transfer. Primary transfer rollers 35Y, 35M, 35C, and 35K for performing primary transfer to positions facing the photosensitive drums 11Y, 11M, 11C, and 11K are disposed on the inner peripheral surface side of the intermediate transfer belt 31.

Around the photosensitive drum 11Y that forms a yellow toner image, a charger 12Y that uniformly charges a surface of the photosensitive drum 11Y, an exposure device 13Y that irradiates the photosensitive drum 11Y with image light to form a latent image on the surface, a development device 14Y that transfers toner to the latent image on the photosensitive drum 11Y to form a toner image, and a cleaning device 15Y that removes toner remaining on the photosensitive drum 11Y after the primary transfer of the toner image are provided. The configuration for forming the magenta, cyan, and black toner images is understood by replacing a suffix Y with M, C, and K in the above description.

On the other hand, when any one of sheet feeding rollers 64,65, and 66 rotates, the sheet material S stored in sheet feeding cassettes 61,62, and 63 is conveyed to a registration roller 21 through a sheet feeding conveyance path 67. The sheet material S is fed by the registration roller 21 to a secondary transfer portion formed by nipping of a secondary transfer roller 41 and the counter roller 32 in timing with the toner image on the intermediate transfer belt 31, and the toner image is formed by the secondary transfer portion. The transfer residual toner remaining on the intermediate transfer belt 31 after the secondary transfer is removed by a cleaning device 36.

Next, the sheet material S to which the toner image has been transferred is conveyed to a heat-fixing device 5 by a conveyance belt 71, and the toner image is fixed on the surface of the sheet material S by press heating by the heat-fixing device 5, whereby a full-color image is fixed. The sheet material S on which the toner image has been fixed is sent to a sheet ejection tray 69 through a sheet ejection conveyance path 68.

In the image forming apparatus 100 illustrated in FIG. 1, the fed sheet material S is conveyed from the right to the left, but the direction is not limited thereto, and the fed sheet material may be conveyed from the left to the right.

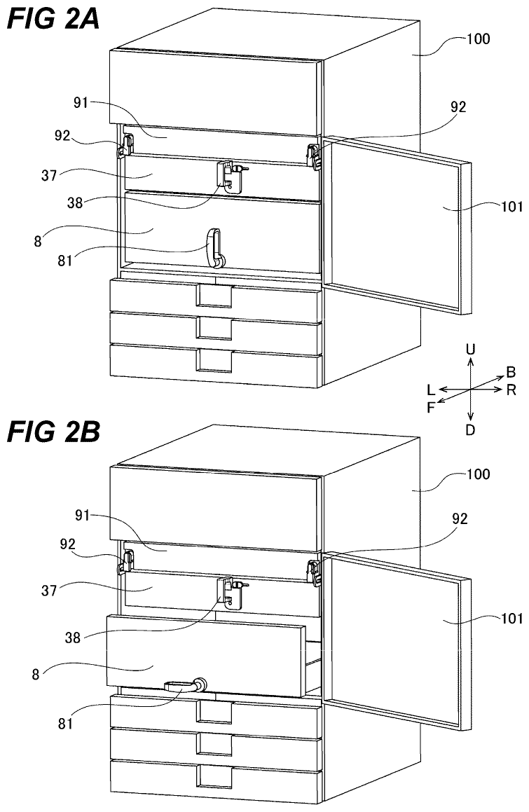

In the following description, an upward direction U, a downward direction D, a rightward direction R, a leftward direction L, a backward direction B, and a forward direction F illustrated in FIGS. 1 and 2 are defined as follows. A direction oriented from the back to the front of the sheet surface of FIG. 1 is defined as the forward direction F, and a direction oriented from the front to the back of the sheet surface of FIG. 1 is defined as the backward direction B. In FIG. 1, when the image forming portion 1K that forms a black K image is used as a reference, the side on which the image forming portion 1Y that forms a yellow Y image is disposed is defined as the left side, and a direction toward the left side is defined as the leftward direction L. When the image forming portion 1Y that forms a yellow Y image is used as a reference, the side on which the image forming portion 1K that forms a black K image is disposed is defined as the right side, and a direction toward the right side is defined as the rightward direction R. Furthermore, a direction that is perpendicular to a front-back direction and a left-right direction defined here and is oriented upward in a vertical direction is defined as the upward direction U, and a direction that is perpendicular to the front-back direction and the left-right direction defined here and is oriented downward in the vertical direction is defined as the downward direction D.

FIGS. 2A and 2B are schematic configuration diagrams of a front door 101 and a conveyance unit 8 of the image forming apparatus 100 according to the present embodiment.

The image forming apparatus 100 includes the front door 101 that covers a front side of an main body. The front door 101 is provided to be openable and closable with respect to the main body of the image forming apparatus 100 as illustrated in FIGS. 2A and 2B. The front side of the main body of the image forming apparatus 100 is covered with the front door 101 at a closing position (not illustrated). That is, a conveyance unit lever 81, an intermediate transfer belt attachment/detachment lever 38, and a process unit cover attachment/detachment lever 92, which are operation levers provided on the front side of the main body, are covered with the front door 101 at the closing position. As illustrated in FIGS. 2A and 2B, a user can access the conveyance unit lever 81, the intermediate transfer belt attachment/detachment lever 38, and the process unit cover attachment/detachment lever 92, which are the operation levers provided on the front side of the main body, by opening the front door 101.

A sheet jam may occur during operation of the image forming apparatus 100. At this time, the user opens the front door 101 as illustrated in FIG. 2A, and rotates the conveyance unit lever 81 from a locking position illustrated in FIG. 2A to an unlocking position illustrated in FIG. 2B. As a result, the conveyance unit 8 is removed from the main body, and a sheet remaining in a sheet conveyance path can be removed by extracting the conveyance unit 8 to the front side.

Note that the conveyance unit 8 is a unit including a conveyance member such as the conveyance belt 71 located between the intermediate transfer belt 31 and the sheet feeding cassette 61 in the image forming apparatus 100 illustrated in FIG. 1. The conveyance unit 8 is a moving member provided to be movable in the front-rear direction with respect to the main body of the image forming apparatus 100. The conveyance unit lever 81, which is an operation lever, is disposed on a front surface of the conveyance unit 8. The conveyance unit lever 81 rotates about a shaft between a locking position illustrated in FIG. 2A where movement of the conveyance unit 8 in the front-rear direction is locked and an unlocking position illustrated in FIG. 2B where the locking is released.

A color of the conveyance unit lever 81, which is an operation lever operated by the user, is set to a color different from that of the conveyance unit 8 such that the user can easily recognize it. That is, the conveyance unit lever 81 has a color different from that of the front surface of the conveyance unit 8 on which the conveyance unit lever 81 is disposed.

A service engineer opens the front door 101 for replacing a process unit, for example. The service engineer opens the front door 101 as illustrated in FIGS. 2A and 2B, so that the service engineer can access the conveyance unit lever 81, the intermediate transfer belt attachment/detachment lever 38, and the process unit cover attachment/detachment lever 92 which are operation levers provided on the front side of the main body.

Here, among the above-described operation levers, the conveyance unit lever 81 is an operation lever operated by the user. On the other hand, the intermediate transfer belt attachment/detachment lever 38 and the process unit cover attachment/detachment lever 92 are levers that are operated by the service engineer, in other words, operation levers that are not operated by the user.

The intermediate transfer belt attachment/detachment lever 38, which is an operation lever not operated by the user, has the same color as a front surface of an intermediate transfer belt frame 37. The process unit cover attachment/detachment lever 92, which is an operation lever not operated by the user, has the same color as the front surface of the process unit cover 91. As a result, the levers are made difficult for the user to recognize.

### [Movement of Intermediate Transfer Belt Unit]

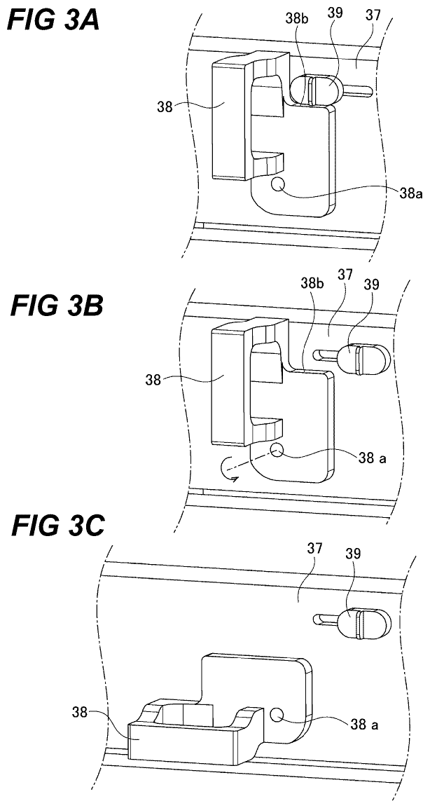

FIGS. 3A to 3C are schematic configuration diagrams of the intermediate transfer belt attachment/detachment lever 38 of the image forming apparatus 100 according to the present embodiment.

The intermediate transfer belt unit is a unit including the intermediate transfer belt 31 located between the photosensitive drum 11 and the conveyance unit 8 in the image forming apparatus 100 illustrated in FIG. 1. The intermediate transfer belt unit is a unit including the intermediate transfer belt 31 that is an internal component of the main body of the image forming apparatus 100. The intermediate transfer belt unit is movably supported by the intermediate transfer belt frame 37 supported by the main body of the image forming apparatus 100. Specifically, the intermediate transfer belt unit is movably supported by the intermediate transfer belt frame 37 as the moving member between a contact position where the intermediate transfer belt 31 is brought into contact with the photosensitive drum 11 as an internal component of the main body and a separation position where the intermediate transfer belt 31 is separated. Here, the intermediate transfer belt frame 37 movably supporting the intermediate transfer belt unit and supported by the main body is a moving member movable with respect to the main body.

The intermediate transfer belt attachment/detachment lever 38, which is an operation lever, is disposed on the front surface of the intermediate transfer belt frame 37, and rotates about a shaft 38a in an axial direction along the front-rear direction of the image forming apparatus 100. Specifically, the intermediate transfer belt attachment/detachment lever 38 rotates about the shaft 38a between a contact position illustrated in FIG. 3A where the intermediate transfer belt 31 is brought into contact with the photosensitive drum 11 and a separation position illustrated in FIG. 3C where the intermediate transfer belt 31 is separated from the photosensitive drum 11.

Although the intermediate transfer belt attachment/detachment lever 38 is rotatable about the shaft 38a, a wall portion 38b of the intermediate transfer belt attachment/detachment lever 38 comes into contact with a lever lock member 39 as illustrated in FIG. 3A such that the user does not unintentionally rotate the intermediate transfer belt attachment/detachment lever.

The lever lock member 39 is a regulating member that is displaced to a regulating position illustrated in FIG. 3A where the rotation of the intermediate transfer belt attachment/detachment lever 38 is regulated and an allowing position illustrated in FIG. 3B where the rotation of the intermediate transfer belt attachment/detachment lever 38 is allowed. As illustrated in FIG. 3A, the lever lock member 39 comes into contact with the wall portion 38b of the intermediate transfer belt attachment/detachment lever 38 at the contact position to regulate the rotation of the intermediate transfer belt attachment/detachment lever 38 at the regulating position.

At the time of operation by the service engineer, the lever lock member 39 is slid to the allowing position illustrated in FIG. 3B as illustrated in FIG. 3B, so that the contact between the lever lock member 39 and the wall portion 38b is released. Therefore, the regulation by the lever lock member 39 is released, and the intermediate transfer belt attachment/detachment lever 38 can be rotated as illustrated in FIG. 3C.

The rotation operation of the intermediate transfer belt attachment/detachment lever 38 lowers the position of the intermediate transfer belt unit, and the intermediate transfer belt 31 and the photosensitive drum 11 change from the contact state to the separation state. Therefore, when the service engineer extracts the process unit to the front side of the image forming apparatus 100 for maintenance work, the surface of the intermediate transfer belt 31 and the surface of the photosensitive drum 11 are not damaged.

The lever lock member 39 has the same color as the front surface of the intermediate transfer belt frame 37 and the intermediate transfer belt attachment/detachment lever 38 such that the user can hardly recognize the lever lock member.

Although the configuration in which the intermediate transfer belt unit is movably supported by the intermediate transfer belt frame 37 is exemplified, the present disclosure is not limited thereto, and the intermediate transfer belt unit may be movably supported by the main body of the image forming apparatus 100. That is, the intermediate transfer belt unit may be a moving member movable with respect to the main body.

Further, the intermediate transfer belt frame 37 may be configured not only to movably support the intermediate transfer belt unit but also to be movably supported in the front-rear direction with respect to the main body of the image forming apparatus 100. In this case, the intermediate transfer belt attachment/detachment lever 38 functions as an operation lever that locks or unlocks the intermediate transfer belt frame 37 as a moving member. Specifically, the intermediate transfer belt attachment/detachment lever 38 has a function of locking the movement of the intermediate transfer belt frame 37 in the front-rear direction at the locking position illustrated in FIG. 3A and allowing the movement of the intermediate transfer belt frame 37 in the front-rear direction at the unlocking position illustrated in FIG. 3C.

### [Opening and Closing of Process Unit Cover]

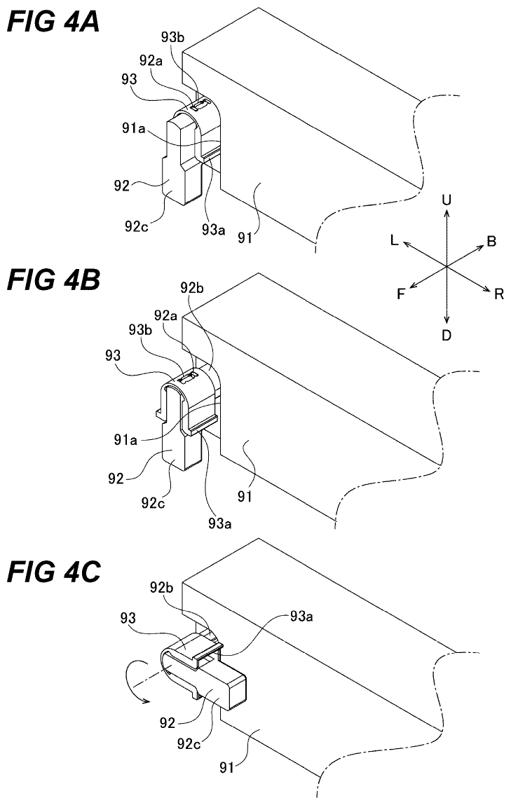

FIGS. 4A to 4C are schematic configuration diagrams of the process unit cover attachment/detachment lever 92 of the image forming apparatus 100 according to the present embodiment. FIG. 4A illustrates a lever locking state, and FIGS. 4B and 4C illustrate a lever unlocking state. Here, a lever disposed on the left side of the process unit cover 91 is exemplified as the process unit cover attachment/detachment lever 92.

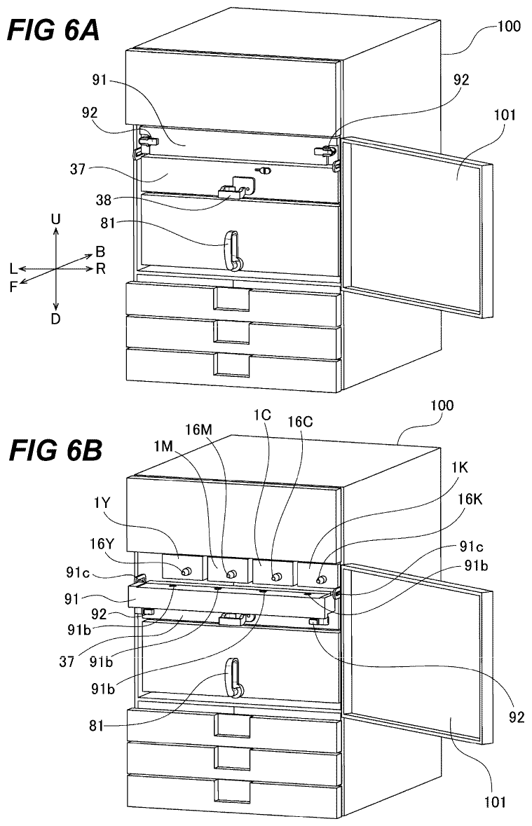

The process unit cover 91 is a moving member movable with respect to the main body of the image forming apparatus 100. The process unit cover 91 is provided on the front side of the main body of the image forming apparatus 100. The process unit cover 91 is a cover that covers a process unit including the photosensitive drum 11 which is an internal component of the main body. The process unit cover 91 moves between a closing position (a position illustrated in FIG. 6A) in which the process unit including the photosensitive drum 11 is covered and an opening position (a position illustrated in FIG. 6B) in which the process unit is exposed.

The process unit cover attachment/detachment lever 92 is provided on the front side of the main body of the image forming apparatus 100 and rotates about a shaft (not illustrated). The process unit cover attachment/detachment lever 92 rotates between a locking position (a position illustrated in FIG. 4A) for locking the process unit cover 91 and an unlocking position (a position illustrated in FIG. 4C) for unlocking the process unit cover. The process unit cover attachment/detachment lever 92 is covered by the front door 101 at the closing position and can be accessed by opening the front door 101. The process unit cover attachment/detachment lever 92 rotates between the locking position where the process unit cover 91 is locked at the closing position and the unlocking position where the locking is released.

As illustrated in FIG. 4B, the process unit cover attachment/detachment lever 92 includes a shaft 92b extending in the front-rear direction of the image forming apparatus 100 and an operation portion 92c extending in a radial direction of the shaft 92b. A lever lock member 93 is attached to the process unit cover attachment/detachment lever 92.

The lever lock member 93 is a regulating member that is displaced to a regulating position (position illustrated in FIG. 4A) for regulating the rotation of the process unit cover attachment/detachment lever 92 and an allowing position (position illustrated in FIG. 4B) for allowing the rotation of the process unit cover attachment/detachment lever 92. The lever lock member 93 regulates the rotation of the process unit cover attachment/detachment lever 92 at the locking position at the regulating position.

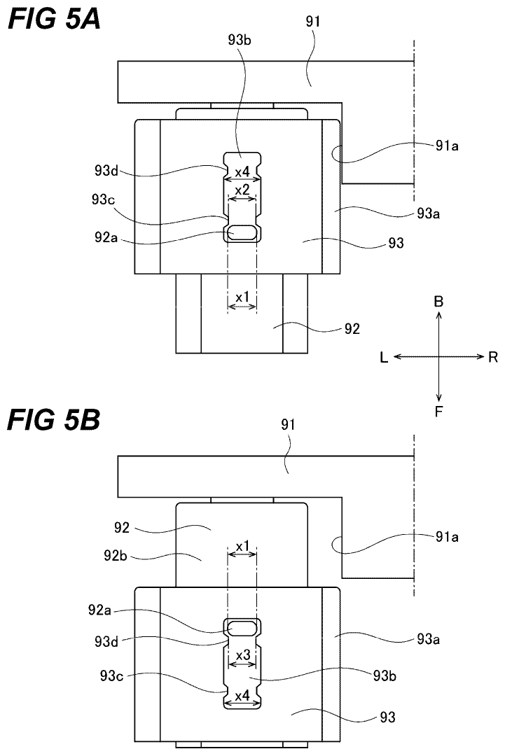

The lever lock member 93 is provided to be movable in the front-rear direction of the image forming apparatus 100 along the shaft 92b with respect to the process unit cover attachment/detachment lever 92. The lever lock member 93 is displaced to the regulating position (position illustrated in FIG. 5A) by being moved in the backward direction B along the shaft 92b, and is displaced to the allowing position (position illustrated in FIG. 5B) by being moved in the forward direction F along the shaft 92b.

Here, the process unit cover attachment/detachment lever 92 comes into contact with the process unit cover 91 as illustrated in FIG. 4A so as not to be unintentionally rotated by the user, thereby entering a lever locking state in which the process unit cover attachment/detachment lever cannot rotate. Specifically, a wall portion 91a provided in the process unit cover 91 and a rotation regulating portion 93a provided in the lever lock member 93 come into contact with each other, so that the process unit cover attachment/detachment lever 92 enters a lever locking state in which it cannot rotate.

At the time of operation by the service engineer, as illustrated in FIG. 4B, the rotation regulating portion 93a and the wall portion 91a do not come into contact with each other by sliding the lever lock member 93 in the forward direction F. As a result, the process unit cover attachment/detachment lever 92 enters a lever unlocking state and can be rotated to the allowing position as illustrated in FIG. 4C.

A fixing mechanism (not illustrated) of the process unit cover 91 with respect to the main body is released by the rotational operation of the process unit cover attachment/detachment lever 92, so that the process unit cover 91 can be extracted to the front side of the image forming apparatus 100.

At the time of releasing the fixing mechanism (not illustrated) of the process unit cover 91 with respect to the main body, the operation portion (gripping portion) 92c of the process unit cover attachment/detachment lever 92 extends in the radial direction of the shaft 92b of the process unit cover attachment/detachment lever 92 in order to perform the operation with a small force by the action of the moment.

As described above, the lever lock member 93 is configured to slide in the front-rear direction of the image forming apparatus 100, thereby achieving space saving. Further, the lever lock member 93 is provided on the front side of the main body, and a case where the lever lock member 93 is displaced in the backward direction B is set to the lever locking state. As a result, even if the user unintentionally touches the process unit cover attachment/detachment lever 92, a force is applied in the backward direction B, and the process unit cover attachment/detachment lever 92 can be prevented from unintentionally entering the lever unlocking state.

The process unit cover attachment/detachment lever 92, which is an operation lever not operated by the user, has the same color as the front surface of the process unit cover 91. The lever lock member 93 has the same color as the front surface of the process unit cover 91. As a result, each member is made difficult for the user to recognize.

FIGS. 5A and 5B are schematic configuration diagrams of the process unit cover attachment/detachment lever 92 and the lever lock member 93, and FIG. 5A illustrates a lever locking state and FIG. 5B illustrates a lever unlocking state.

The process unit cover attachment/detachment lever 92 includes a protrusion portion 92a having a protrusion width x1 in the left-right direction orthogonal to the front-rear direction of the main body. The lever lock member 93 has a groove portion 93b that movably engages with the protrusion portion 92a in the front-rear direction.

The groove portion 93b is a groove portion having a groove width x4 larger than the protrusion width x1 and extending in the front-rear direction. The groove portion 93b includes a first narrowed portion 93c fitted to the protrusion portion 92a at the regulating position and a second narrowed portion 93d fitted to the protrusion portion 92a at the allowing position. The first narrowed portion 93c has a groove width x2 smaller than the protrusion width x1. The second narrowed portion 93d has a groove width x3 smaller than the protrusion width x1.

The groove portion 93b provided in the lever lock member 93 is fitted to the protrusion portion 92a provided in the process unit cover attachment/detachment lever 92, so that the lever lock member 93 is positioned by the process unit cover attachment/detachment lever 92, and is slidable in the front-rear direction.

In the lever locking state (regulating position) illustrated in FIG. 5A, a relationship between the protrusion width x1 of the protrusion portion 92a and the groove width x2 of the first narrowed portion 93c of the groove portion 93b satisfies x1>x2. Therefore, even if the user unintentionally touches the lever lock member 93, the lever lock member 93 cannot be easily slid forward. When the service engineer pulls the lever lock member 93 in the forward direction F with a certain force or more, the first narrowed portion 93c is elastically deformed and expanded, and the lever lock member 93 can be slid with a click feeling.

Even in the lever unlocking state (allowing position) illustrated in FIG. 5B, a relationship between the protrusion width x1 of the protrusion portion 92a and the groove width x3 of the second narrowed portion 93d of the groove portion 93b satisfies x1>x3. This prevents that when the service engineer performs the rotational operation of the process unit cover attachment/detachment lever 92, the service engineer touches and easily slides the lever lock member 93 to hinder the rotational operation of the process unit cover attachment/detachment lever 92. When the service engineer pushes the lever lock member 93 in the backward direction B with a certain force or more, the second narrowed portion 93d is elastically deformed and expanded, and the lever lock member 93 can be slid with a click feeling.

That is, when the lever locking state and the lever unlocking state are switched, the lever lock member 93 is slid in the front-rear direction with two click feelings. However, the number of click feelings is not limited to two. That is, the number of narrowed portions included in the groove portion is not limited to the above-described number, and may be appropriately provided.

In addition, the configuration in which the protrusion portion 92a is provided in the process unit cover attachment/detachment lever 92 and the groove portion 93b is provided in the lever lock member 93 has been exemplified, but the present disclosure is not limited thereto. The protrusion portion 92a may be provided in the lever lock member 93, and the groove portion 93b may be provided in the process unit cover attachment/detachment lever 92. That is, the protrusion portion 92a may be provided in one of the process unit cover attachment/detachment lever 92 and the lever lock member 93, and the groove portion 93b may be provided in the other of the process unit cover attachment/detachment lever 92 and the lever lock member 93.

### [Attachment/Detachment of Process Unit]

FIGS. 6A and 6B are schematic configuration diagrams illustrating a detachment state of the process unit cover 91 in the image forming apparatus 100 according to the present embodiment.

The process unit cover 91 is a cover that covers the photosensitive drum which is an internal component. The process unit cover 91 has a positioning hole 91b which is a positioning portion that engages with a drum shaft 16 of the photosensitive drum 11 at the closing position illustrated in FIG. 6A and positions the photosensitive drum 11. The process unit cover 91 has a photosensitive drum positioning hole 91b for each process unit.

The process unit cover 91 rotates to the opening position illustrated in FIG. 6B to release the positioning of the photosensitive drum 11 by the positioning hole 91b.

As illustrated in FIG. 6A, by rotating the process unit cover attachment/detachment lever 92, a fixing mechanism (not illustrated) of the process unit cover 91 with respect to the main body (main body frame) is released, and the process unit cover 91 can be extracted in the forward direction F.

Further, the process unit cover 91 extracted in the forward direction F is rotated about a rotation shaft 91c extending in the horizontal direction as illustrated in FIG. 6B. The rotation shaft 91c is provided at each of both ends of the process unit cover 91 in the horizontal direction. By rotating the process unit cover 91, a space on the front side of the process unit 1 is opened, and the process unit 1 of each color can be accessed from the front side of the main body.

The process unit 1 of each color is fitted to the drum shaft 16 arranged to extend in the front-rear direction of the main body. The process unit 1 can be extracted in the forward direction F along the drum shaft 16. As illustrated in FIG. 6A, when the process unit cover 91 covers the front side of the process unit 1, the positioning hole 91b provided in the process unit cover 91 is fitted to the drum shaft 16. As a result, the process unit 1 is positioned with respect to the main body (main body frame).

Although the process unit 1 includes the photosensitive drum 11, by covering the front side with the process unit cover 91 described above, it is possible to simultaneously perform the work of shielding the photosensitive drum 11 from light and the work of positioning the process unit 1 with respect to the main body frame.

As described above, according to the present embodiment, it is possible to prevent the user from unintentionally operating the operation lever without impairing the workability of the service engineer.

In the embodiment described above, the photosensitive drum and the intermediate transfer belt have been exemplified as the internal components of the image forming apparatus, but the present disclosure is not limited thereto.

In the embodiment described above, four image forming portions are used, but the number of image forming portions used is not limited, and may be appropriately set as necessary.

In the embodiment described above, the laser scanner is used as the exposure device, but the present disclosure is not limited thereto, and for example, an LED array may be used.

In addition, in the embodiment described above, as the process unit attachable to and detachable from the image forming apparatus, the process cartridge integrally including a photosensitive drum, and a charging portion, a developing portion, and a cleaning portion as process portions acting on the photosensitive drum has been exemplified. However, the unit attachable to and detachable from the image forming apparatus is not limited thereto. For example, the unit may be a unit integrally including any one of the charging portion, the developing portion, and the cleaning portion in addition to the photosensitive drum.

Further, in the embodiment described above, the printer has been exemplified as the image forming apparatus, but the present disclosure is not limited thereto. For example, another image forming apparatus such as a copying machine or a facsimile machine, or another image forming apparatus such as a multifunction machine obtained by combining these functions may be used. In addition, the image forming apparatus has been exemplified in which an intermediate transfer member is used, toner images of respective colors are transferred to the intermediate transfer member in a sequentially superimposed manner, and the toner images carried on the intermediate transfer member are collectively transferred to a recording material, but the present disclosure is not limited thereto. For example, the image forming apparatus may be an image forming apparatus in which a recording material carrier is used, and toner images of respective colors are transferred to the recording material carried on the recording material carrier in a sequentially superimposed manner. Similar effects can be obtained by applying the present disclosure to these image forming apparatuses.

Furthermore, in the embodiment described above, the electrophotographic system has been exemplified as the recording system, but the present disclosure is not limited thereto, and for example, another recording system such as an inkjet system may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-147447, filed Aug. 29, 2024, which is hereby incorporated by reference herein in its entirety.

1. An image forming apparatus comprising:
a main body;
a front door configured to cover a front side of the main body;
a moving member configured to move with respect to the main body;
an operation lever provided on the front side of the main body and configured to rotate between a locking position for locking the moving member and an unlocking position for unlocking the moving member, the operation lever being covered by the front door and being accessible by opening the front door; and
a regulating member configured to move at least to a regulating position for regulating a rotation of the operation lever and to an allowing position for allowing the rotation of the operation lever.

2. The image forming apparatus according to claim 1, wherein
the moving member is a moving member that is provided on the front side of the main body and moves between a closing position for covering an internal component of the main body and an opening position for exposing the internal component,
the operation lever rotates between the locking position for locking the moving member at the closing position and the unlocking position for unlocking the moving member, and
the regulating member regulates the rotation of the operation lever at the locking position at the regulating position.

3. The image forming apparatus according to claim 2, wherein
the moving member is a cover that covers a photoreceptor to be the internal component, and includes a positioning portion that engages with the photoreceptor at the closing position and positions the photoreceptor.

4. The image forming apparatus according to claim 2, wherein
the regulating member is provided to be movable in a front-rear direction of the main body along a shaft with respect to the operation lever, and is displaced to the regulating position or the allowing position by being moved in the front-rear direction along the shaft.

5. The image forming apparatus according to claim 4, further comprising:
a protrusion portion provided in one of the operation lever and the regulating member and having a protrusion width in a direction orthogonal to the front-rear direction of the main body; and
a groove portion provided in the other of the operation lever and the regulating member and movably engaging with the protrusion portion in the front-rear direction, the groove portion having a groove width larger than the protrusion width and extending in the front-rear direction, wherein
the groove portion includes a first narrowed portion that has a groove width smaller than the protrusion width and is fitted to the protrusion portion at the regulating position, and a second narrowed portion that has a groove width smaller than the protrusion width and is fitted to the protrusion portion at the allowing position.

6. The image forming apparatus according to claim 5, wherein
the operation lever includes a shaft that extends in the front-rear direction of the main body and an operation portion that extends in a radial direction of the shaft.

7. The image forming apparatus according to claim 1, wherein
the moving member is a unit including an intermediate transfer member to be an internal component of the main body, and is provided to be movable between a contact position where the intermediate transfer member is brought into contact with a photoreceptor to be an internal component of the main body and a separation position where the intermediate transfer member is separated from the photoreceptor,
the operation lever is disposed on a front surface of the unit and rotates between the contact position where the intermediate transfer member is brought into contact with the photoreceptor and the separation position where the intermediate transfer member is separated from the photoreceptor, and
the regulating member regulates the rotation of the operation lever at the contact position at the regulating position.

8. The image forming apparatus according to claim 2, wherein
the operation lever and the regulating member have the same color as a front surface of the moving member on which the operation lever is disposed.
